(19) United States
(12) Patent Application Publication
(10) Pub. No.: US 2009/0209291 A1
(43) Pub. Date: Aug. 20, 2009

(54) WIRELESS COMMUNICATION DEVICE AND METHOD WITH EXPEDITED CONNECTION RELEASE

(75) Inventors: SATISH RAMPRASAD, BOYNTON, FL (US); JAMES RHETT AULTMAN, PLANTATION, FL (US); CARLOS A. RIVERA-CINTRON, LAKE WORTH, FL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 12/033,109

(22) Filed: Feb. 19, 2008

(51) Int. Cl. H04B 1/38

(52) U.S. Cl. 455/564

(57) ABSTRACT

A wireless communication device (200) and method (300) with an expedited connection release. The method (300) includes: providing (310) a wireless communication device, configured to send and receive wireless signals, the wireless communication device including a controller configured to control the operations of the wireless communication device; communicating (320) traffic messages between a transceiver of the wireless communication device and a radio access network; identifying (330) acceptable traffic messages in a rules database free from triggering a firewall event; and determining (340) if the traffic messages do not match the rules database, defining an unacceptable traffic message, and in the event of an unacceptable traffic message triggering the firewall event and substantially immediately triggering a connection release. This arrangement can prolong battery life in communication devices and enhance a user's experience.

### BACKGROUND

1. Field

The present disclosure is directed to wireless communications, and particularly to a packet filtering device and method to initiate an expedited connection release.

2. Introduction

Wireless communication and computing devices, such as mobile devices, operate with a limited energy supply, such as a battery, fuel cell or the like. While the energy supply is generally rechargeable, it may not always be convenient or even possible for a user to recharge the energy supply. Accordingly, there is a need to maximize the useful time of device operation.

Thus, there is a need for filtering undesirable and unacceptable messages, traffic and/or data, in order to conserve energy, prolong useful battery life and to provide an enhanced user experience dismissing undesirable traffic. In more detail, automatic filtering based on certain rules, for minimizing processing of incoming unnecessary, undesired or malicious traffic and messages, would be an improvement in the art.

In many networks, such as Wideband Code Division Multiple Access (WCDMA) networks, there is a problem in that a significant amount of current drain in mobiles or user equipment (UE), is associated with small amounts of data. The data channels have been optimized for large amounts of streaming data very efficiently. Thus, deploying WCDMA devices, that maintain an IP adapter, in the field require that the UE, be in a CONNECTED radio state, thereby significantly draining battery life. Examples of these small amounts of data, are DOS, ping, malicious or otherwise unexpected or undesired request, sent to a UE.

There is a need for a solution, to employ packet filtering and firewall techniques as a means of initiating a UE triggered connection release, enabling the UE to quickly transition out of a connected state to an idle state, thereby significantly improving the power management of a UE.

Always on connection features are deployed by productivity devices or UEs, that support email clients, IM clients, VOIP, PTT over IP networks capabilities and the like. This solution is adaptable for use in many radio access technologies and is particularly adapted for use in the 3GPP TS 25.331 RRC Protocol Specification (section 8.1.14).

In more detail, WCDMA devices generally have an “always-on” data connection. A user's experience can suffer with the degradation of the energy storage device. A purpose for keeping the always-on connection on, is to receive traffic which arrives only once every several minutes. Under unrealistically ideal conditions, no other network traffic would arrive except for this email. However, real world conditions show that there is quite often a significant amount of spurious, undesirable traffic such as ICMP pings, attempts to connect to services the device does not support, hackers scanning for open ports, and worms probing for attack vectors. Every time the UE receives one of these packets, it must go to a high power consumption state to respond to the packet (connection state) and then wait for the network to let it return to a lower power state (idle state). The time it takes the WCDMA network to do this may be sufficiently long enough that another undesirable packet can arrives in the interim. This can keep the device in a state of high power consumption for long periods of time.

Thus, there is a need to enable a wireless device to quickly transition out of a connected state to an idle state, to dismiss the processing of unwanted traffic and prolong the useful life of an energy storage device.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment;

FIG. 2 is an exemplary block diagram of a wireless communication device according to one embodiment;

FIG. 3 is an exemplary block diagram of a wireless communication according to one embodiment;

FIG. 4 is an exemplary flowchart illustrating the operation of a wireless communication device and particularly the operation of the fire wall according to one embodiment;

FIG. 5 is an exemplary flowchart illustrating the operation of a wireless communication device and particularly an user equipment (UE) Initiated Connection Release according to one embodiment;

FIG. 6 is an exemplary flowchart illustrating the operation of a wireless communication device according to another embodiment;

FIG. 7 is a first power consumption graph for Example 1 and is for a first handset on a network configured timeout, to take the device from RRC state CONNECTED to RRC state IDLE, illustrating the operation of a wireless communication device not according to an embodiment of the instant disclosure;

FIG. 8 is a second power consumption graph for results corresponding to Example 2 and is for a handset on a network configured timeout, to take the device from RRC state CONNECTED to RRC state IDLE, illustrating the operation of a wireless communication device not according to an embodiment of the instant disclosure; and

FIG. 9 is a third power consumption graph for results corresponding to Example 3 and is for a handset configured with a handset firewall and timeout, to take the device from RRC state CONNECTED to RRC state IDLE, illustrating the operation of a wireless communication device according to an embodiment of this disclosure.

### DETAILED DESCRIPTION

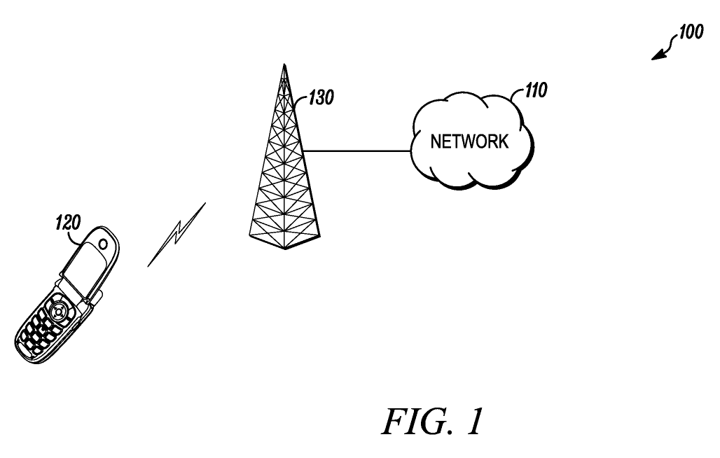

FIG. 1 is an exemplary block diagram of a system 100 according to one embodiment. The system 100 can include a network 110, a terminal 120, and a base station 130. The terminal 120 may be a wireless communication device, such as a wireless telephone, a cellular telephone, a personal digital assistant, a pager, a personal computer, a selective call receiver, or any other device that is capable of sending and receiving communication signals on a network including wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, a Third Generation (3G) network, a Wideband Code Division Multiple Access (WCDMA) network, a satellite communications network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130.

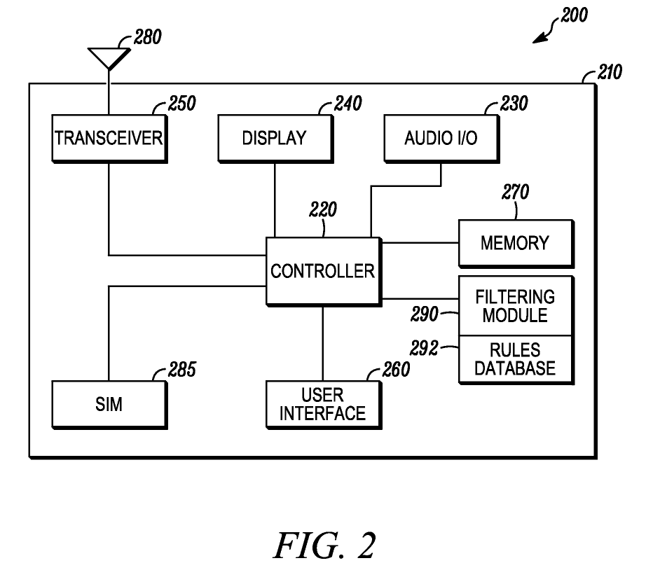

FIG. 2 is an exemplary block diagram of a wireless communication device 200, such as the terminal 120, according to one embodiment. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220. The wireless communication device 200 can include wireless communication device 200 also includes a filtering module 290 with a rules database 292, which are coupled to the controller 220. In more detail, they can reside within the controller 220, can reside within the memory 270, can be autonomous modules, can be software, can be hardware, or can be in any other format useful for a module on a wireless communication device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

In more detail, the wireless communication device 200 shown in FIG. 2, includes: a housing 210; a controller 220 coupled to the housing 210, the controller 220 configured to control the operations of the wireless communication device; memory 270 coupled to the controller 220; memory 270 coupled to the controller 220; a transceiver 250 coupled to the controller 220, the transceiver 250 having an idle state and a connected state in which the transceiver 25 receives traffic messages from a base station, the connected state transitions to the idle state after a timeout period; and

a filtering module 290 configured to identify acceptable traffic messages in a rules database 292 free from triggering a firewall event and determine if the traffic messages do not match the rules database 292, defining an unacceptable traffic message, and in the event of an unacceptable traffic message triggering a firewall event and substantially immediately triggering a connection release.

Advantageously, the filtering module 290 can quickly trigger a connection release of a spurious, undesirable or unacceptable traffic message, dynamically managing and minimizing unnecessary and undesirable current drain of a wireless communication device, configured with an energy storage device such as a battery, a fuel cell or electrochemical capacitor, for example. This can enhance the useful life of the energy storage device and improve a user's experience by doing so.

In connection with the subject of packet filtering placement, placing a packet filter on routers at the network has some advantages. First, if undesirable traffic is filtered out by the network rather than on the UE, then the traffic is never delivered at all and the UE will remain in a low-power state more often. Another advantage is that the hardware used in network routers is often specially designed for high-speed data packet analysis, resulting in less disruption to the speed of the data flow due to traffic analysis. In contrast, there are disadvantages to placing the packet filter at routers on the network, such as the network is in control of maintenance of packet filter rules. If a user installs a new data application on the device or UE, network packet filter rules would not be promptly updated and the application may not work.

In addition, a packet filter on a device has the ability to stop outgoing traffic on the device before baseband resources are dedicated to sending it. In this case, a packet filter on a device, for example, would be able to blunt the damage from a malicious program on the device which sends out meaningless data, which unnecessarily takes up valuable network and UE resources and drains a UE battery. A network packet filter would not be as effective in this particular example.

Examples of “unacceptable” traffic messages can include: an ICMP ping; a socket open requests on a DS-port; a socket open requests on a epmap-port; and a socket open requests on a netbios-port.

In the context of this application, packets are considered “undesirable or unacceptable” for at least one of the following reasons: 1.) The traffic is not necessary or meaningful to the services and applications supported by the device. 2.) The traffic will cause higher consumption of energy as baseband processor resources are used to both consume and respond to the traffic, and as this traffic is neither necessary nor meaningful, there is no actual utility realized from this energy expense. 3.) The traffic may be part of malicious activity, such as a hacker scanning for open ports of a device or a worm testing attack vectors.

Also in the context of this application, an IP datagram is a sequence of bytes received via the UE data connection which conforms to Internet Engineering Task Forc (IETF) Request For Comments (RFC) 791 (http://www.ietf.org/rfc/rfc0791.txt). In connection with the examination of IP datagrams herein, they generally consists of two sections—the header and the payload. The header is a sequence of bytes divided into a number of fields of different lengths. The lengths of the fields in the IP datagram header, the order of the fields, and the interpretation of the various values allowed in the fields is described in the above RFC.

Specifically, there are four fields in an IP datagram of concern, namely, the protocol type field, the message type field, the source IP address field and the destination IP address field. The protocol type field takes on unique values to denote if the payload of the IP datagram is a TCP datagram, UDP datagram, ICMP message, or some other protocol. In one embodiment, the message type field is used herein, only if the protocol field denotes ICMP, and differentiates between different types of ICMP messages (such as ECHO REQUEST, which is a ping). The scope of ICMP message types, as well as the formatting of ICMP messages is described by IETF RCF 792 (http://www.ietf.org/rfc/rfc792.txt). The source IP address field denotes the address of the device which originally sent the datagram. The destination IP address field denotes the address of the device to receive the datagram.

A TCP datagram is defined as an IP datagram which has a protocol type field set to the appropriate value to denote TCP and which has a payload that conforms to the standard specified in IETF RFC 793 (http://www.ietf.org/rfc/rfc793.txt). Within the payload section of the IP datagram, the TCP standard specifies a header section and a payload section. The TCP header is broken up into a series of fields. In a preferred embodiment, important to this invention, are the source port and destination port fields. These denote ports, or points of delivery to software applications, on the source and destination machines. The most popular data applications use a common set of ports. HTTP servers are generally bound to port 80 of their host machines, for example.

A UDP datagram is defined similar to that of a TCP datagram, but is specified by IETF RFC 768 (http://www.ietf.org/rfc/rfc768.txt). IP datagrams containing UDP data have a different value in their protocol field. The header of a UDP datagram also contains source and destination port fields. The range of values supported by these fields is the same as that for TCP, but TCP datagrams and UDP datagrams having the same number in their destination port fields will not necessarily be delivered to the same application; thus, the spaces of TCP ports and UDP ports can be considered disjoint.

With the above definitions, one can now continue with the following definitions:

An ICMP ping is defined as a well-formed IP datagram with a protocol type field set to specify ICMP and a message type field set to specify ECHO REQUEST.

A socket open request on the DS port is defined as a well-formed IP datagram with a protocol type field set to specify TCP and the TCP payload section properly conforming to the standards of RFC 768 for a TCP SYN request.

A socket open request on the DS port is defined as any socket open request which satisfies all the previously given criteria and has a destination port field set to 445, the port number for the DS service.

A socket open request on the EPMAP port is defined as any socket open request which satisfies the previously given criteria and has a destination port field set to 135, the port number for the EPMAP service.

A socket open request on the NETBIOS port is defined as any socket open request which satisfies all the previously given criteria and has a destination port field set to 139, the port number for the NETBIOS service.

In a preferred embodiment and in the context of the instant invention, the following are examples of unacceptable traffic messages: a ICMP ping, a socket open requests on a DS-port, socket open request on a epmap-port, socket open requests on a netbios-port, for the reasons detailed herein and because they are considered spurious and detract from a user experience, as they cause unnecessary or undesirable traffic and power drain.

In a preferred embodiment, the connection release procedure is substantially in compliance with a 3GPP specification, to solve and minimize current drain issues related to this specification, and which can relate to the always-on feature detailed herein.

In one embodiment, the filtering module 290 is configured to allow customizing of the rules database 292 to add, modify or delete the identified acceptable traffic messages. This feature allows the module to be adjusted dynamically as needed. For example, in the event a user installs a new data application on a wireless device, network packet filter rules would likely not be promptly updated and the application would not likely work, as designed. In addition, a packet filter on the device has the ability to stop outgoing traffic on the device before baseband resources are required and dedicated to sending it. In these cases, customization of acceptable traffic messages would be quite helpful. A network packet filter would not be as effective in these cases.

Accordingly, in a preferred embodiment, the filtering module 290 is configured to match and monitor incoming and outgoing traffic messages against the rules database 292 to determine if the traffic is acceptable or unacceptable traffic messages. This can reside in the wireless communication device 200 or at the radio access network, for the reasons detailed herein.

The energy storage device comprises at least one of a battery, a fuel cell, a fuel container and an electrochemical capacitor.

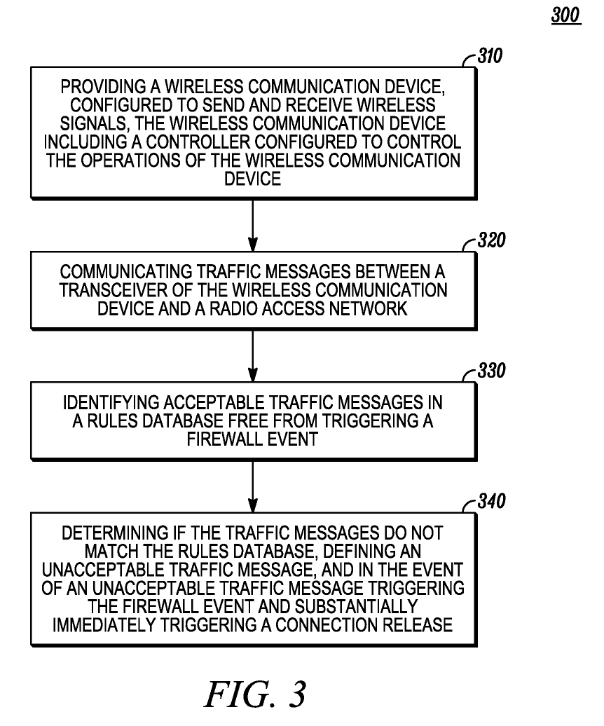

Turning to FIG. 3, a wireless communication method 300 is shown. It can include: providing 310 a wireless communication device, configured to send and receive wireless signals, the wireless communication device including a controller configured to control the operations of the wireless communication device; communicating 320 traffic messages between a transceiver of the wireless communication device and a radio access network; identifying 330 acceptable traffic messages in a rules database free from triggering a firewall event; and determining 340 if the traffic messages do not match the rules database, defining an unacceptable traffic message, and in the event of an unacceptable traffic message triggering the firewall event and substantially immediately triggering a radio layer connection release.

Stated in another way, the wireless communication device 200 and method 300 provide a solution to automatically filter or eliminate undesirable traffic messages, for example, according to a rules database 292, to enhanced a user experience by initiating an expedited radio layer connection release and prolonging battery life in communication devices.

Stated slightly differently, by providing some intelligence embedded in a handset, advantageously provides a feature, that as soon as it is determined that the traffic is meaningless or an unacceptable traffic message, the handset is substantially immediately shut down and moved to a low power or sleep state, thus minimizing unnecessary power drain to a handset or UE.

In one arrangement, the method 300 can further include customizing the rules database to identify a plurality of acceptable traffic messages. This arrangement allows a module to be adjusted dynamically as needed. For example, in the event a user installs a new data application on a wireless device, network packet filter rules would likely not be promptly updated and the application would not likely work, as designed. In addition, a packet filter on the device has the ability to stop outgoing traffic on the device before baseband resources are dedicated to sending it. In these cases, customization of acceptable traffic messages would be quite helpful.

In a preferred embodiment, the determining step 340 includes matching incoming and outgoing traffic messages against the rules database, to determine if it comprises acceptable or unacceptable traffic messages. Advantageously, this can provide filtering both ways. Stated differently, the packet filtering herein, can apply rules on both inbound and outbound packets. The mechanism is similar to that already described, though the rules used for outbound packets would be adapted for outbound messaging whereas those for inbound packets would be adapted for inbound traffic, as should be understood by those skilled in the art.

More specifically, the method 300 can further include forwarding the acceptable traffic messages to an IP stack of the wireless communication device, such as L2 for further processing.

In a preferred embodiment, the identifying step 330 includes populating header information in the rules database including providing a source IP address, a protocol type, a message type, a destination port and a source port for each of the acceptable traffic messages. As understood in the art, networks are not homogenous with respect to the characteristics of the undesirable traffic they handle. For example, it is envisioned that wireless communication devices would likely be shipped or provided with a default set of rules designed to allow (through common use applications, mail, streaming audio/video, web browsing, etc) and block a number of known cases of undesirable traffic. The flexibility of being able to update the rules database would allow IT managers with an understanding of the security conditions and specific application configurations of their devices, to further adapt, specialize and customize the rules to their needs.

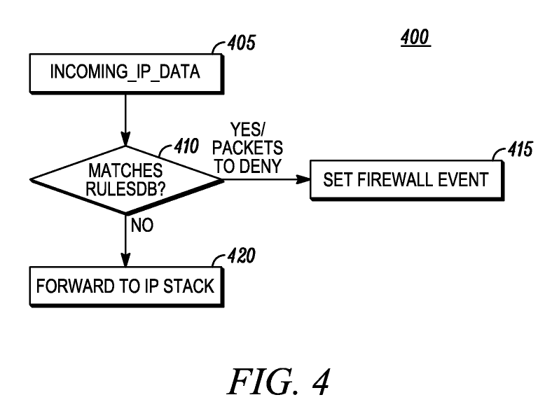

FIG. 4 is an exemplary flowchart 400 illustrating the operation of the fire wall, according to one embodiment. In step 405, the flowchart begins with an IP datagram being delivered from the baseband processing layer. In decision box 410, the inquiry is: do the header fields of the IP datagram, and those of any TCP or UDP datagram in its payload, conform to any rules indicating this packet is undesirable traffic? If yes, proceed to box 415, which indicates that the firewall event will be set. This will cause the device, if it was in a connection released state prior to step 405, to return to the connection released state. If no, proceed to step 420, which will allow the IP datagram to be processed by the device. An important feature of the firewall is that it allows the device in the connection released state to rapidly return to this state when the only traffic it receives is undesirable traffic. As the fire wall prevents the transmission of the undesirable traffic to any application on the device, it also optimizes the device's current draw by immediately returning to the dormant state (if it was in one already) when undesirable traffic is received. Without this feature, the device would have to wait a specified period of time to return to the connection released state and, while it could exhibit an improvement in its energy consumption, the improvement would be less significant.

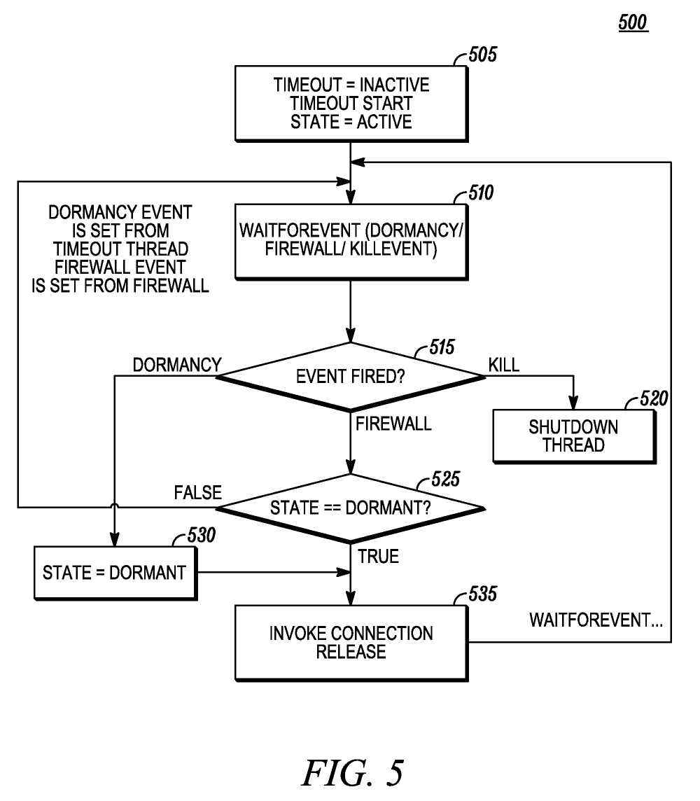

FIG. 5 is an exemplary flowchart 500 illustrating an user equipment (UE) Initiated Connection Release, according to one embodiment. In step 505, the flowchart begins with the initialization of the system state by setting the system state to active and starting the linger timeout. The flowchart proceeds to step 510 where the system waits on a number of events, such as the linger timeout event, the dormancy event, and the firewall event. Each of these events is a signal of specific actions which happen asynchronously to the events in this flow chart. When one of these events is triggered, decision box 515 is reached. The question in decision box 515 is “Which of the three events was triggered?”

If the linger timeout event is triggered, then flow moves down the path marked “kill” and reaches step 520, where the entire data stack is shut down.

If the firewall event is triggered (triggering the firewall event occurs in FIG. 4), decision box 525 is reached and the system state is tested. If the system is not already in the dormant state, then flow returns to step 510.

If the system is in the dormant state, however, step 535 is reached. In step 535, the UE initiates a connection release and then returns to step 510.

If the dormancy event is triggered, then the system state is changed to the dormant state in step 530 before moving to step 535 which initiates the connection release and then goes to step 510.

FIG. 5 details the process by which the significant reductions in energy use are achieved. The first of these mechanisms is the path indicated by steps 530 and 535. This initiates a connection release driven by the dormancy event. This event is a timeout event that is triggered after no traffic has been received within a certain period of time. In a preferred embodiment, the timeout for this event is shorter than the timers used on a network, connection release is always initiated by the device more quickly than a network would issue a connection release, saving energy. The second important feature is the one described by the firewall event and step 525. This event is triggered whenever the firewall encounters undesirable traffic. If this event is triggered while the device is already in the connection released state, then the device will re-issue the connection release and return to the released state. This ensures that the device spends as little energy as possible, handling and discarding the undesirable traffic, rather than waiting on the dormancy event. The difference in time spent out of the connection released state is on the order of seconds, which denotes a significant saving of energy.

In a preferred embodiment, the filtering module is configured to sense an absence of traffic messages for a certain period of time (or senses a predetermined dormancy period) and triggers a connection release substantially immediately after the certain period of time (dormancy period) has elapsed. Also preferred, is that the dormancy period be set in the UE for about five seconds or less, for minimizing unnecessary current drain.

Absent from this figure is the process by which the device reaches the active state after going to the dormant state. This happens whenever the device receives desirable traffic, which should be understood by those skilled in the art.

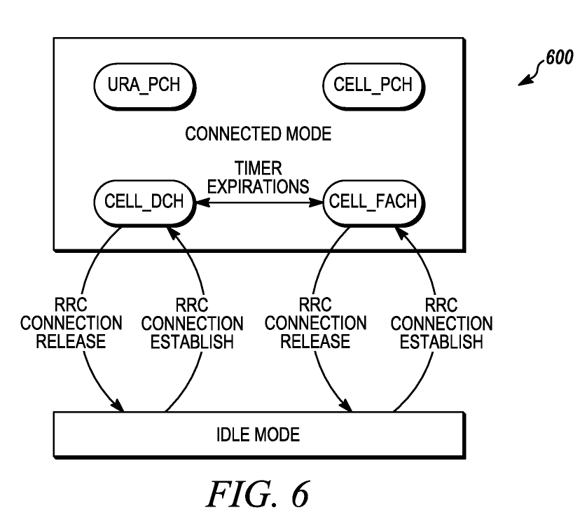

FIG. 6, is an exemplary block diagram 600 of a Radio Resource Controller communication states according to one embodiment. The instant disclosure is particularly adapted for use in a WCDMA radio resource controller (RRC). It should be understood by those skilled in the art that the instant disclosure has application in other systems as well. In WCDMA networks, the RRC protocol assigns radio resources between the UE and the network. The RRC has the following states:

CELL_DCH: Dedicated channel is allocated to the UE. This is for the highest throughput, and lowest latency. Maximum power consumption is at this state.

CELL_FACH: In this state, the phone shares the channel with other phones. This state is normally used when there is minimal data to transmit, and the power consumption is lower than in CELL_DCH.

CELL_PCH: This state is used for paging the phone to enter into CELL_DCH/CELL_FACH states. URA_PCH is identical to CELL_PCH but the location of the MT is known on a UTRAN Registration Area Level. This is an optional state.

IDLE: In this state, the phone cannot send or receive packets. It has a valid PDP context (IP address), and can be paged to enter into CELL_DCH/CELL_FACH to transmit/receive data.

Based on the above, any spurious packets received at the UE will result in the UE transitioning out of the IDLE state to one of the CONNECTED states (CELL_DCH/CELL_FACH) for significant amounts of time. Depending on the nature of the incoming packet, it may further involve additional acts, thereby delaying the movement of the UE back to IDLE. In a preferred embodiment, packets are examined and filtered and move the UE to IDLE substantially instantaneously, thereby significantly saving power and minimizing an undesirable use of resources.

UMTS networks employ inactivity timers to transition between CELL_DCH→CELL_FACH→CELL_PCH→IDLE states. Currently, these inactivity timers are set at the network by the operator, and are configured for minimum latency and thereby maximizing throughput. In one embodiment, the power consumed by remaining idle in the CELL_DCH state is in the order of 400 mA, and in the CELL_FACH state is in the order of 150 mA. The time that a UE remains in a state that is not IDLE is about 10-20 seconds, thereby significantly increasing the current drain in the device. It is up to the operator network configuration to set the threshold for the CELL_FACH state, thereby transitioning to the highest power consuming CELL_DCH state.

The CELL_PCH and URA_PCH states as described above are optional. In most network implementations, the states present are CELL_DCH and CELL_FACH in the CONNECTED MODE. As soon as a data transfer starts, the RRC connection state moves to CELL_FACH state. The threshold of the state transition to CELL_DCH is controlled by the TE, and may take the UE to the CELL_DCH state. For a network implemented timeout back to IDLE, the network may use a variable timeout value, to wait in the CELL_FACH state, after which it transitions the UE to IDLE. For ping packets that are small in nature, each unwanted packet will introduce this state transition to CELL_FACH and remain there until the network times out and takes the RRC mode to IDLE. Preferably, once an unwanted packet is detected, the UE immediately requests and initiates a connection release, thus transitioning the UE from the CELL_FACH/CELL_DCH states in the CONNECTED MODE to IDLE MODE, thereby saving power.

The timeout value is governed by network operators. They are generally arbitrary. For example, in some regions they are set at 10 seconds, while others set this value as high as 30 seconds.

### COMPARATIVE EXAMPLES

A first handset with an active data connection was allowed to go into the connection release state and then to idle, its mode of lowest power consumption. A second device issued an ICMP ECHO REQUEST (commonly called a “ping” or “ICMP ping”) that was 32 bytes in length. The power consumption graphs reflect the power and time used as the first handset receives and processes the packet and returns to its connection released state. The handsets used to send and receive the ping were both Motorola Q9h and both had data connections provided by a local AT&T network in Plantation, Fla. This network supported the CELL_DCH and CELL_FACH states only in a CONNECTED mode. The handset under test was a 3G/HSDPA enabled cellular phone. For all three tests, the network dormancy timeout was 10 seconds, for transitioning from CONNECTED to the IDLE mode, in the event of no traffic activity.

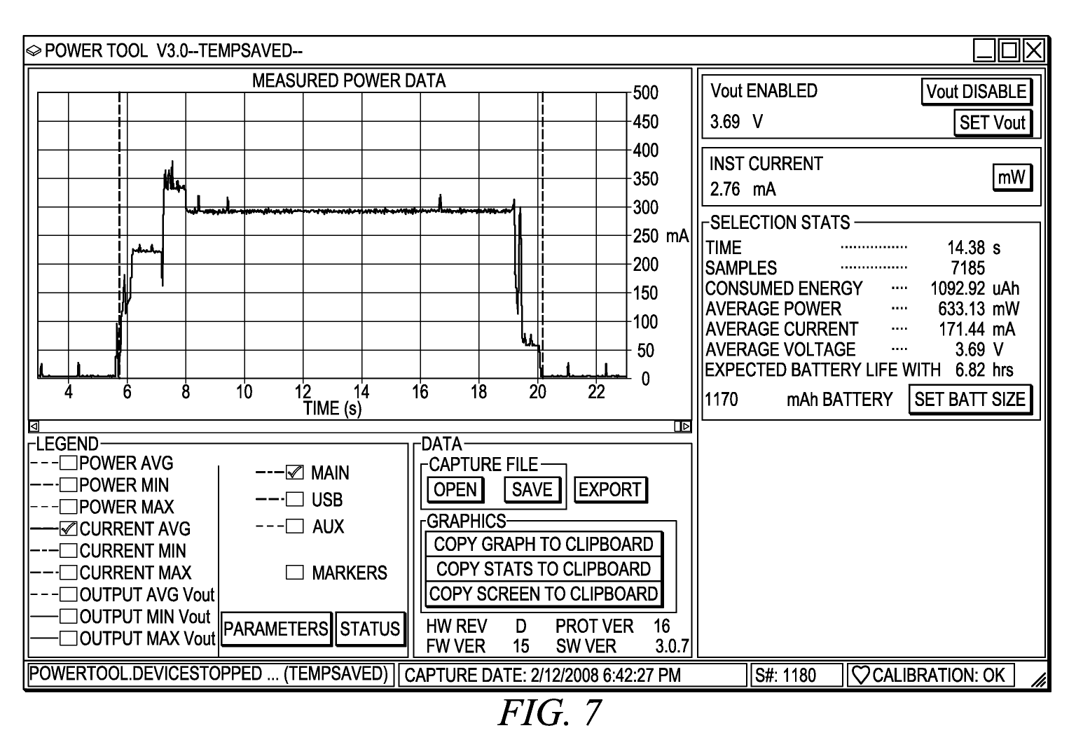

FIG. 7 is a first power consumption graph for Example 1, illustrating and demonstrating he operation of a wireless communication device not according to an embodiment of the instant disclosure. Average Current consumption for ping packet was 1095 uAh. This test is a control and does not include a handset dormancy time out feature and expedited initiation to idle.

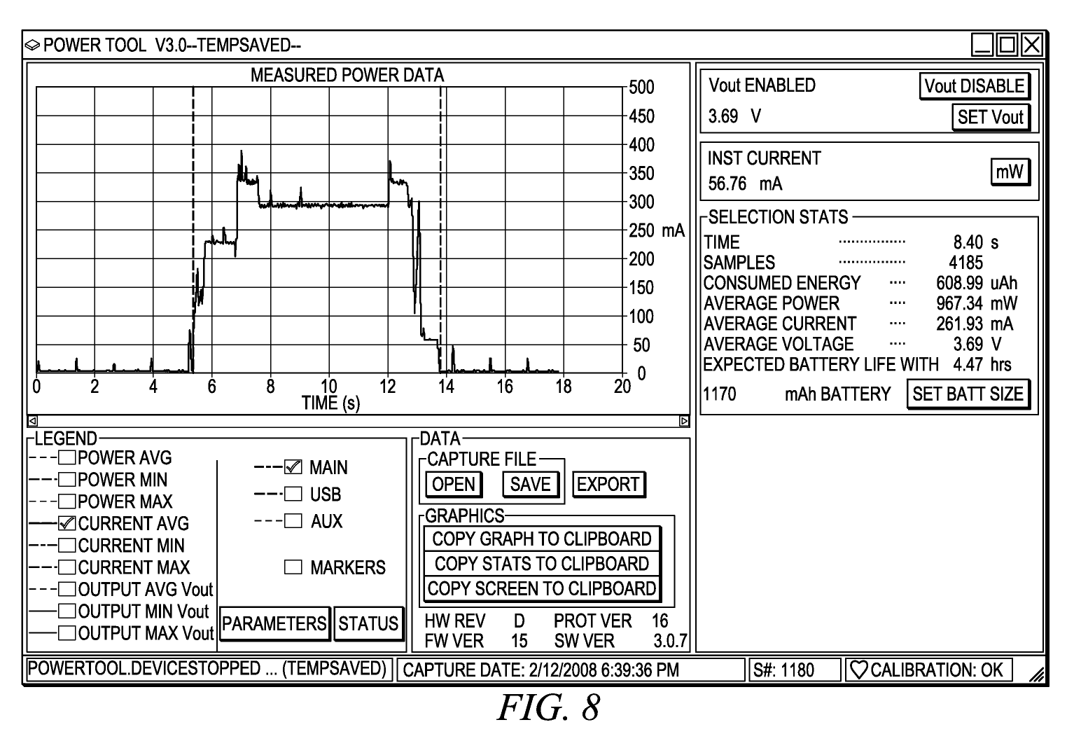

FIG. 8 is a second power consumption graph for results corresponding to Example 2. This test illustrates the operation of a wireless communication device with a dormancy time out set at the headset for five seconds. This test shows some improvement over Example 1. Average Current consumption for ping packet was 608.99 uAh.

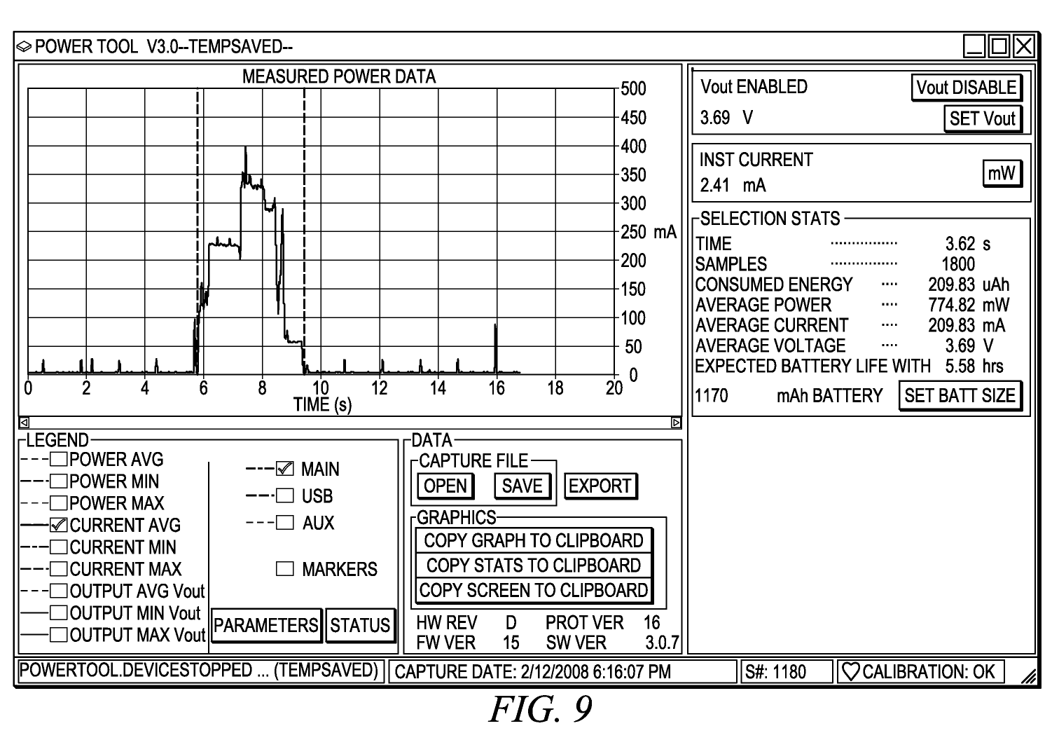

FIG. 9 is another power consumption graph for results corresponding to Example 3 demonstrating the invention. In this test, the handset was equipped with a firewall as detailed herein, that takes the handset from RRC state CONNECTED to RRC state IDLE, substantially immediately when an unacceptable traffic message is detected. The handset also had a dormancy time out set at five seconds, but it was never triggered during this test. Average Current consumption for ping packet was 209.83 uAh. This Example is over a two times improvement over Example 2, which has a dormancy feature only. As noted previously, some known networks have a thirty second dormancy time out, and Example 3 would provide a substantial improvement over such a network.

The device 200, method 300 and process flows herein are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication device configured with an expedited connection release, comprising:
a housing;
a controller coupled to the housing, the controller configured to control the operations of the wireless communication device;
memory coupled to the controller;
a transceiver coupled to the controller, the transceiver having an idle state and a connected state in which the transceiver receives traffic messages from a base station, the connected state transitions to the idle state after a timeout period; and
a filtering module configured to identify acceptable traffic messages in a rules database free from triggering a firewall event and determine if the traffic messages do not match the rules database, defining an unacceptable traffic message, and in the event of an unacceptable traffic message triggering the firewall event and substantially immediately triggering a connection release.

2. The wireless communication device of claim 1, wherein the unacceptable traffic message includes at least one of:
an ICMP ping;
a socket open requests on a DS-port;
a socket open requests on a epmap-port; and
a socket open requests on a netbios-port.

3. The wireless communication device of claim 1, wherein the connection release procedure is substantially in compliance with a 3GPP specification.

4. The wireless communication device of claim 1, wherein the filtering module is configured to sense an absence of traffic messages for a certain period of time and triggers a connection release substantially immediately after the certain period of time has elapsed.

5. The wireless communication device of claim 1, wherein the filtering module is configured to allow customizing of the rules database to add, modify or delete the identified acceptable traffic messages.

6. The wireless communication device of claim 1, wherein the filtering module is configured to match and monitor incoming and outgoing traffic messages against the rules database to determine if it comprises acceptable or unacceptable traffic messages.

7. The wireless communication device of claim 1, the filtering module is configured to match and monitor incoming and outgoing traffic messages against the rules database to determine if it comprises acceptable or unacceptable traffic messages, located at, at least one of the wireless communication device and the radio access network.

8. The wireless communication device of claim 1, wherein the energy storage device comprises at least one of a battery, a fuel cell, a fuel container and an electrochemical capacitor.

9. A wireless communication device configured with an expedited connection release, comprising:
a housing;
a controller coupled to the housing, the controller configured to control the operations of the wireless communication device;
memory coupled to the controller;
a transceiver coupled to the controller, the transceiver having an idle state and a connected state in which the transceiver receives traffic messages from a base station, the connected state transitions to the idle state after a timeout period;
a filtering module configured to identify acceptable traffic messages in a rules database free from triggering a firewall event and determine if the traffic messages do not match the rules database, defining an unacceptable traffic message, and in the event of an unacceptable traffic message triggering the firewall event and substantially immediately triggering a radio layer connection release; and
an energy storage device.

10. The wireless communication device of claim 9, wherein the radio layer connection release procedure is substantially in compliance with a 3GPP specification.

11. A wireless communication method, comprising:
providing a wireless communication device, configured to send and receive wireless signals, the wireless communication device including a controller configured to control the operations of the wireless communication device;
communicating traffic messages between a transceiver of the wireless communication device and a radio access network;
identifying acceptable traffic messages in a rules database free from triggering a firewall event; and
determining if the traffic messages do not match the rules database, defining an unacceptable traffic message, and in the event of an unacceptable traffic message triggering the firewall event and substantially immediately triggering a connection release.

12. The wireless communication method of claim 11, further comprising customizing the rules database to identify a plurality of acceptable traffic messages.

13. The wireless communication method of claim 11, wherein the determining step includes matching incoming and outgoing traffic messages against the rules database to determine if it comprises acceptable or unacceptable traffic messages.

14. The wireless communication method of claim 11, wherein the determining step includes matching incoming and outgoing traffic messages against the rules database to determine if it comprises acceptable or unacceptable traffic messages, located at, at least one of the wireless communication device and the radio access network.

15. The wireless communication method of claim 11, wherein the unacceptable traffic message includes at least one of:
an ICMP ping;
a socket open requests on a DS-port;
a socket open requests on a epmap-port; and
a socket open requests on a netbios-port.

16. The wireless communication method of claim 11, further comprising forwarding the acceptable traffic messages to an IP stack of the wireless communication device.

17. The wireless communication method of claim 11, wherein the identifying step includes populating header information in the rules database including providing a source IP address, a protocol type, a message type, a destination port and a source port for each of the acceptable traffic messages.

18. The wireless communication method of claim 11, further comprising sensing absence of traffic messages for a certain period of time and triggering a connection release substantially immediately after the certain period of time has elapsed.
